(19) United States
(12) Patent Application Publication
(10) Pub. No.: US 2013/0135527 A1
(43) Pub. Date: May 30, 2013

(54) DISPLAY DEVICE AND IMAGE DISPLAY METHOD

(71) Applicant: JAPAN DISPLAY EAST INC., Mobara-shi (JP)

(72) Inventors: Nobuhiro TAKEDA, Mobara (JP); Shinichi IWASAKI, Mobara (JP)

(73) Assignee: JAPAN DISPLAY EAST INC., Mobara-shi (JP)

(21) Appl. No.: 13/680,225

(22) Filed: Nov. 19, 2012

(30) Foreign Application Priority Data
Nov. 24, 2011 (JP) 2011-256016

(51) Int. Cl. H04N 5/06

(52) U.S. Cl. CPC H04N 5/06
USPC 348/521

(57) ABSTRACT

A wireless communication failure caused by electromagnetic waves generated from a display device is reduced. The display device includes a driver circuit that is arranged on a display panel, and applies a voltage corresponding to a gradation value to each pixel, a video signal line for transmitting a video signal to the driver circuit, a control signal line for transmitting a signal for controlling a timing at which the video signal is transmitted to the driver circuit, and a video signal control unit that transmits the video signal to the driver circuit through the video signal line and the control signal line, in which a transmission clock frequency at which the video signal control unit transmits the video signal to the driver circuit is different from an external clock frequency at which the video signal control unit receives the video signal from an external.

### CROSS-REFERENCE TO RELATED APPLICATION

The present application claims priority from Japanese application JP 2011-256016 filed on Nov. 24, 2011, the content of which is hereby incorporated by reference into this application.

### BACKGROUND OF THE INVENTION

1. Field of the Invention

The present invention relates to a display device and a video display method.

2. Description of the Related Art

As a display device of an information communication terminal such as a computer or of as a television receiver, liquid crystal display devices have been extensively used. Also, an organic EL display device (OLED) and a field emission display device (FED) have been known as thin display devices. The display devices of this type is incorporated into a mobile terminal such as a cellular phone, and used as an output device to a user. The mobile terminal frequently has a wireless communication function, and there has been known that electromagnetic waves emitted from the display device are affected on the wireless communication.

JP 06-037478 A discloses that a metal foil is attached to an input interface signal wiring or a power supply wiring to reduce an EMI (electromagnetic interface).

Also, JP 11-133921 A discloses a binary display and a gradation display in an SIN reflection liquid crystal display device in which any one of a clock transmitted by a clock transmitter and a clock divided by a frequency divider is selected to be used as a frame frequency, and switched, for the purpose of reducing a power consumption.

Also, JP 05-289769 A discloses that, for the purpose of reducing a power consumption of a personal digital assistant, a clock frequency is switched according to a clock frequency switching command, and the clock frequency is also switched according to a length of a processing waiting time.

### SUMMARY OF THE INVENTION

Particularly, in recent tablet mobile terminals of the above-mentioned mobile terminals, a control IC (integrated circuit) is frequently separated from a driver IC. In this configuration, when an image signal is transmitted from the control IC to the driver IC, the electromagnetic waves generated from a flexible printed board have a tendency to increase, and it is conceivable that the electromagnetic waves have no small effect on the wireless communication. As a countermeasure against such electromagnetic waves, a shield member as disclosed in JP 06-037478 A can be added. However, the addition of the member and the addition of man-hour lead to an increase in the manufacturing costs of the terminal.

The present invention has been made in view of the above circumstances, and aims at reducing a wireless communication failure caused by the electromagnetic waves generated from the display device.

According to the present invention, there is provided a display device, including: a driver circuit that is arranged on a display panel, and applies a voltage corresponding to a gradation value to each pixel; a video signal line for transmitting a video signal to the driver circuit; a control signal line for transmitting a signal for controlling a timing at which the video signal is transmitted to the driver circuit; and a video signal control unit that transmits the video signal to the driver circuit through the video signal line and the control signal line, in which a transmission clock frequency at which the video signal control unit transmits the video signal to the driver circuit is different from an external clock frequency at which the video signal control unit receives the video signal from an external.

Also, in the display device according to the present invention, the video signal is transmitted at the transmission clock frequency higher than the external clock frequency.

Also, in the display device according to the present invention, the video signal control unit can transmit a plurality of the video signals corresponding to different display positions to functional portions of the driver circuit corresponding to the plurality of video signals at the same time, respectively.

Also, in the display device according to the present invention, the video signal control unit transmits the respective video signals by using a plurality of the transmission clock frequencies in a plurality of time zones, and the plurality of transmission clock frequencies includes a first transmission clock frequency and a second transmission clock frequency which is an integral multiple of the first transmission clock frequency.

Also, in the display device according to the present invention, the transmission clock frequency is set to a clock frequency that does not interfere with a wireless frequency used for the wireless communication, with respect to the wireless communication unit that conducts an external wireless communication. In this case, the clock frequency that does not interfere with the wireless frequency can be set to a frequency different from an integer multiple and an integral fraction of the wireless frequency.

According to the present invention, there is provided a video display method, including: inputting and storing a video signal at a timing of an external clock signal; transmitting the stored video signal to a driver circuit at a timing of a transmission clock signal; and outputting the transmitted video signal by the driver circuit for display, in which the transmission clock frequency is different from the external clock frequency.

### BRIEF DESCRIPTION OF THE DRAWINGS

FIG. 1 is a diagram illustrating a liquid crystal display device according to an embodiment of the present invention;

FIG. 2 is a diagram illustrating a system configuration of the display device illustrated in FIG. 1 according to the present invention;

FIG. 3 is a timing chart of a signal related to input/output of a video signal control unit according to a first embodiment;

FIG. 4 is a timing chart of a signal related to input/output of a video signal control unit according to a second embodiment;

FIG. 5 is a timing chart of a signal related to input/output of a video signal control unit according to a third embodiment; and

FIG. 6 is a timing chart of a signal related to input/output of a video signal control unit according to a fourth embodiment.

### DETAILED DESCRIPTION OF THE INVENTION

Hereinafter, embodiments of the present invention will be described with reference to the accompanying drawings. In the drawings, the same or equivalent elements are denoted by identical reference numerals or symbols, and a repetitive description will be omitted.

### First Embodiment

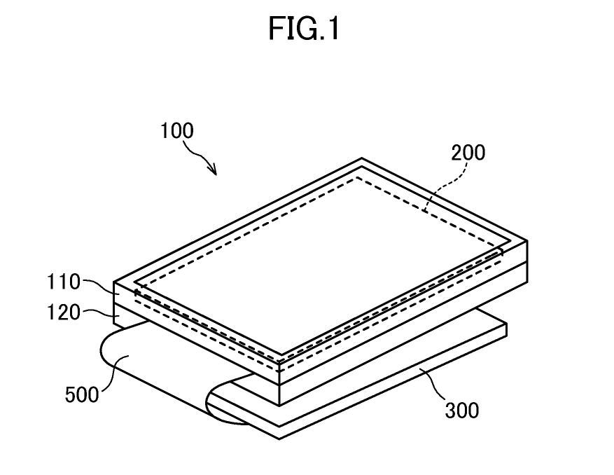

FIG. 1 is a diagram illustrating a display device 100 according to a first embodiment of the present invention. In this example, the display device 100 according to this embodiment may be applicable to any display device such as a liquid crystal display device or an organic EL (electro-luminescent) display device, which provides each pixel with a brightness corresponding to a gradation value for display. As illustrated in the figure, the display device 100 includes an upper frame 110 and a lower frame 120 that fixedly sandwich a display panel 200 therebetween, a video signal control unit 300 that converts video information into a format that can be displayed on the display panel 200 according to an instruction from a main control unit not shown, and a flexible printed circuit (FPC) 500 that transmits information converted in the video signal control unit 300 to the display panel 200.

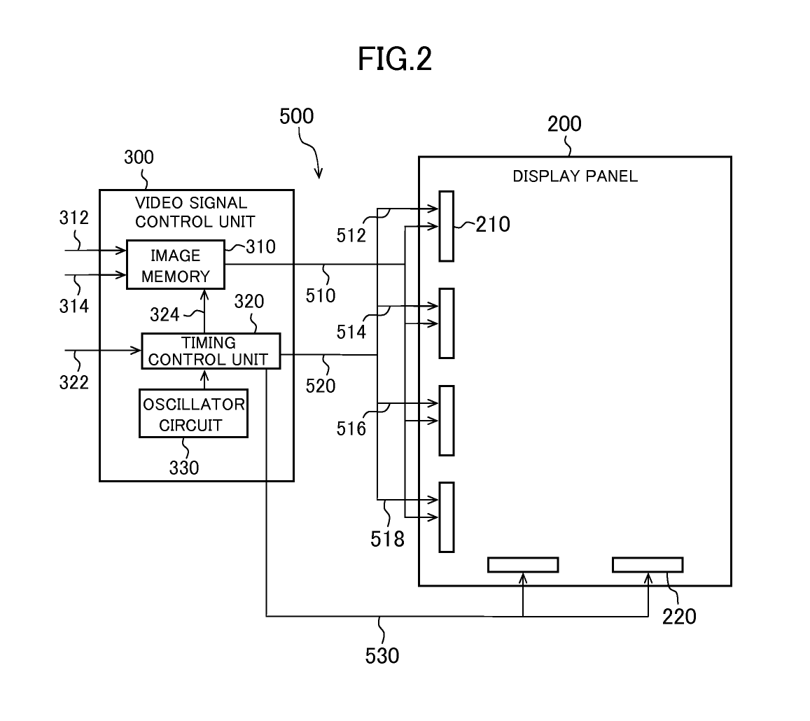

FIG. 2 illustrates a system configuration of the display device 100 illustrated in FIG. 1 according to the present invention. As illustrated in FIG. 2, the video signal control unit 300 includes an oscillator circuit 330, a timing control unit 320, and an image memory 310. The oscillator circuit 330 is formed of a crystal oscillator and the like, and outputs a given clock signal. The timing control unit 320 receives the clock signal output from the oscillator circuit 330, and allows a frequency to be set from an external through a frequency setting signal line 322. Then, the timing control unit 320 outputs the set frequency as a transmission clock to a transmission clock signal line 324, agate control signal line 530, and a source control signal line 520. The image memory 310 stores a video signal input from an input video signal line 312 at a timing of an external clock input from an external clock signal line 314 into an internal memory. The image memory 310 also outputs the video signal to the display panel 200 through a video signal line 510 at a timing of the transmission clock input from the transmission clock signal line 324.

The display panel 200 includes gate drivers 220 and source drivers 210. The gate drivers 220 each output a scanning signal which is a timing signal for writing a voltage corresponding to a gradation value to scanning signal lines of pixel transistors within a display region not shown. The source drivers 210 each output a voltage corresponding to the gradation value to each of the pixel transistors at a timing of the scanning signal. Also, the input video signal line 312 can double as the frequency setting signal line 322 in a disable period of the video signal.

The video signal line 510, the source control signal line 520, and the gate control signal line 530 for transmitting the signals to the display panel 200 from the video signal control unit 300 are provided on the flexible printed circuit 500.

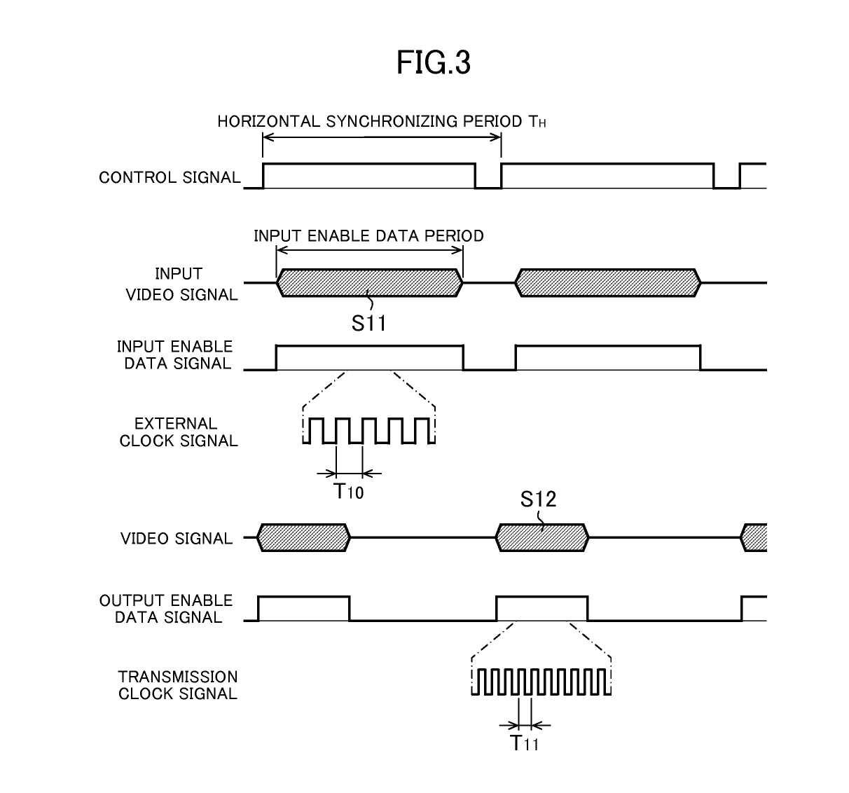

FIG. 3 is a timing chart of the signals related to input/output of the video signal control unit 300 in the system configuration of FIG. 2. The timing chart represents a control signal which is a horizontal synchronizing signal indicative of a period during which data for one line in a display screen is transmitted from an external. The timing chart also represents, as signals to be stored in the image memory 310, an input enable data signal indicating that a signal to be supplied to the input video signal line 312 is enabled, an external clock signal to be supplied to the external clock signal line 314, and an input video signal to be supplied to the input video signal line 312. The timing chart further represents, as signals for outputting the video signal from the video signal control unit 300, an output enable data signal, which is a signal to be supplied to the source control signal line 520, and indicates that the signal to be supplied to the video signal line 510 is enabled, a transmission clock signal to be supplied to the transmission clock signal line 324, and a video signal to be supplied to the video signal line 510. Both of the input video signal line 312 and the video signal line 510 according to this embodiment are parallel signal lines of the same number of bits, for example, 24 bits.

As illustrated in FIG. 3, an input video signal S11 is stored in the image memory 310 in a high period during which the input enable data signal is enabled. In this example, the external clock signal to be used is a clock signal having a given period conforming to resolution on the basis of a period (normally, about 1/60 seconds) displayed in one screen. Then, the video signal stored in the image memory 310 is transmitted to the source drivers 210 as a video signal S12 in the period where the output enable data signal is high. In this example, because a period T₁₁ of the transmission clock signal is shorter than a period T₁₀ of the external clock signal, the video signal is transmitted to the source drivers 210 from the external in a time shorter than a time during which the video signal is stored in the image memory 310. Also, in order to avoid an interference with the wireless communication, a frequency different from an integer multiple or an integral fraction of the wireless frequency used in the wireless communication can be used as the frequency of the transmission clock signal.

Therefore, according to this embodiment, a clock cycle (or frequency) used for transmission of the video signal to be transmitted by the flexible printed circuit 500 can be selected. Therefore, when the clock cycle is set to a cycle in which no wireless communication fails, the wireless communication failure caused by the electromagnetic wave generated from the display device can be reduced without any addition of components, such as a shield member, associated with changing a structure.

In this embodiment, the video signal is transmitted from the video signal control unit 300 to the display panel 200 with the use of the transmission clock signal of the shorter cycle. Alternatively, the transmission clock signal of the longer cycle can be used. Similarly, in this case, a cycle that allows data for one line in the screen to be transmitted in a period longer than the horizontal synchronizing period cannot be selected.

### Second Embodiment

A second embodiment of the present invention will be described. A configuration of a display device and a system configuration according to the second embodiment are identical with those in the first embodiment except for the configurations of the source drivers 210 and the flexible printed circuit 500, and a repetitive description will be omitted.

The second embodiment will be described with reference to FIG. 2 as in the first embodiment. In this embodiment, the source driver 210 is functionally divided into four pieces, and can receive the video signals of four different portions of the display region at the same time. The respective corresponding functional portions of the source drivers 210 are connected with a first video signal line 512, a second video signal line 514, a third video signal line 516, and a fourth video signal line 518 which are different parallel signal lines of six bits. In the above-mentioned first embodiment, the above functions are not required, and the source drivers 210 may not have such functions.

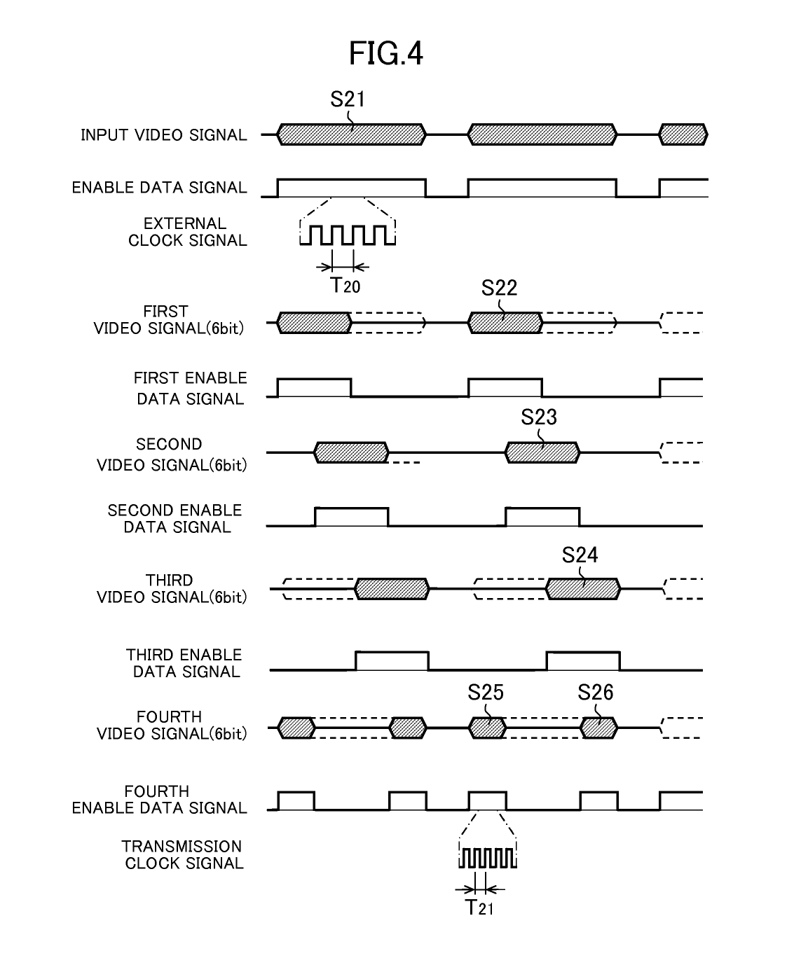

FIG. 4 is a timing chart of a signal related to input/output of the video signal control unit 300 in the system configuration according to this embodiment. As illustrated in the figure, the four divided source drivers 210 receive a first enable data signal to a fourth enable data signal to be supplied to the respective source control signal lines 520 which are a plurality of lines. The source drivers 210 also receive a first video signal to a fourth video signal to be supplied to the first video signal line 512 to the fourth video signal line 518, respectively. Those signals are transmitted at a timing of the transmission clock signal. In this example, the first to fourth video signals correspond to the respective different display positions.

As illustrated in FIG. 4, the first enable data signal to the fourth enable data signal are high at the respective different timings. Two enable data signals of those four enable data signals are arranged to temporally overlap with each other. First, an input video signal S21 is stored in the image memory 310 by the aid of the external clock signal as in the first embodiment. Then, in a subsequent horizontal synchronizing period in which the input video signal S21 is received, the transmission of a first video signal S22 and a fourth video signal S25 to a source driver starts at the same time. During transmission of the first video signal S22, the transmission of the fourth video signal S25 is finished, and at the same time, the transmission of a second video signal S23 starts. Subsequently, during transmission of the second video signal S23, the transmission of the first video signal S22 is finished, and at the same time, the transmission of a third video signal S24 starts. Finally, during transmission of the third video signal S24, the transmission of the second video signal S23 is finished, and the transmission of a fourth video signal S26 starts. The transmission of the third video signal S24 and the fourth video signal S26 are finished within the horizontal synchronizing period at the same time.

As described above, the first video signal to the fourth video signal are the respective parallel signals of 6 bits, and two of the first video signal to the fourth video signal are transmitted at the same time. Therefore, 12 bits in total are transmitted at the same time. Because the input video signal is 24 bits, if the first to fourth video signals are transmitted in the same period as that of the input data signal, a period T₂₁ of the transmission clock signal is set to ½ of a period T₂₀ of the external clock signal, thereby enabling transfer of the same amount of data in the same period.

In this embodiment, two of the four enable data signals are arranged to overlap with each other. However, the distribution of a period during which each enable data signal is high can be appropriately changed so that three or more enable data signals overlap with each other, or none of those enable data signals overlaps with each other.

Therefore, according to this embodiment, a clock cycle (or frequency) used for transmission of the video signal to be transmitted by the flexible printed circuit 500 can be selected. Therefore, when the clock cycle is set to a cycle in which no wireless communication fails, the wireless communication failure caused by the electromagnetic wave generated from the display device can be reduced without any addition of a specific component.

Also, according to this embodiment, because the transfer period is divided, a current consumption can be dispersed, and the deterioration of a power supply voltage caused by a temporal excessive current can be suppressed.

### Third Embodiment

A third embodiment of the present invention will be described. A display device according to the third embodiment is identical with that in the second embodiment except that the first video signal line 512, the second video signal line 514, the third video signal line 516, and the fourth video signal line 518 each of which is the parallel signal line of 6 bits in the second embodiment are each changed to a parallel signal line of 24 bits, and a repetitive description will be omitted.

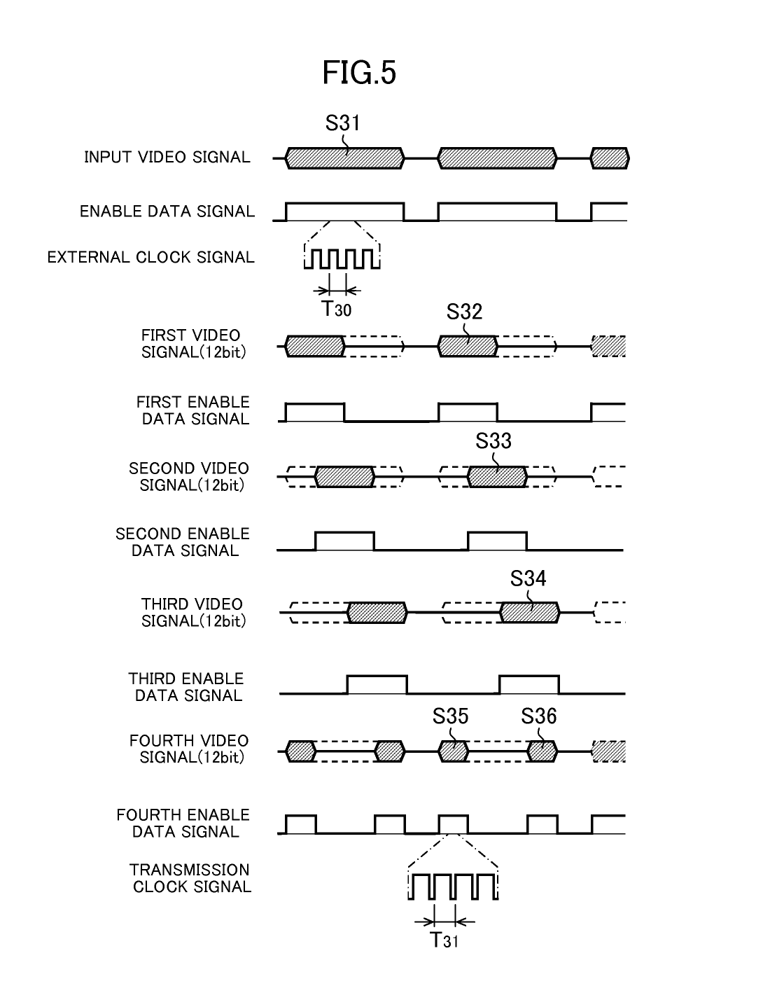

FIG. 5 is a timing chart of a signal related to input/output of the video signal control unit 300 in the system configuration according to this embodiment. Similarly to FIG. 4, the first enable data signal to the fourth enable data signal are high at the respective different timings. Two enable data signals of those four enable data signals are arranged to temporally overlap with each other.

As illustrated in FIG. 5, first, an input video signal S31 is stored in the image memory 310 by the aid of the external clock signal similarly to the second embodiment. Then, in a subsequent horizontal synchronizing period in which the input video signal S31 is received, the transmission of a first video signal S32 and a fourth video signal S35 to a source driver starts at the same time. During transmission of the first video signal S32, the transmission of the fourth video signal S35 is finished, and at the same time, the transmission of a second video signal S33 starts. Subsequently, during transmission of the second video signal S33, the transmission of the first video signal S32 is finished, and at the same time, the transmission of a third video signal S34 starts. Finally, during transmission of the third video signal S34, the transmission of the second video signal S33 is finished, and the transmission of a fourth video signal S36 starts. The transmission of the third video signal S34 and the fourth video signal S36 are finished within the horizontal synchronizing period at the same time.

A difference from the second embodiment resides in that the first video signal to the fourth video signals are the respective parallel signals of 24 bits, and two enable data signals are transmitted at the same time, and therefore 48 bits in total are transmitted at the same time. Because the input video signal is 24 bits, if the first to fourth video signals are transmitted in the same period as that of the input data signal, a period T₃₁ of the transmission clock signal is set to twice as long as a period T₃₀ of the external clock signal, to thereby enable the same amount of data to be transferred in the same period.

In this embodiment, two of the four enable data signals are arranged to overlap with each other. However, the distribution of a period during which each enable data signal is high can be appropriately changed so that three or more enable data signals overlap with each other, or none of those enable data signals overlaps with each other.

Therefore, according to this embodiment, a clock cycle (or frequency) used for transmission of the video signal to be transmitted by the flexible printed circuit 500 can be selected. Therefore, when the clock cycle is set to a cycle in which no wireless communication fails, the wireless communication failure caused by the electromagnetic wave generated from the display device can be reduced without any addition of a specific component.

Also, because the transfer period is divided, a current consumption can be dispersed, and the deterioration of a power supply voltage caused by a temporal excessive current can be suppressed.

### Fourth Embodiment

A fourth embodiment of the present invention will be described. A configuration of a display device and a system configuration according to the fourth embodiment are identical with those in the first embodiment, and a repetitive description will be omitted.

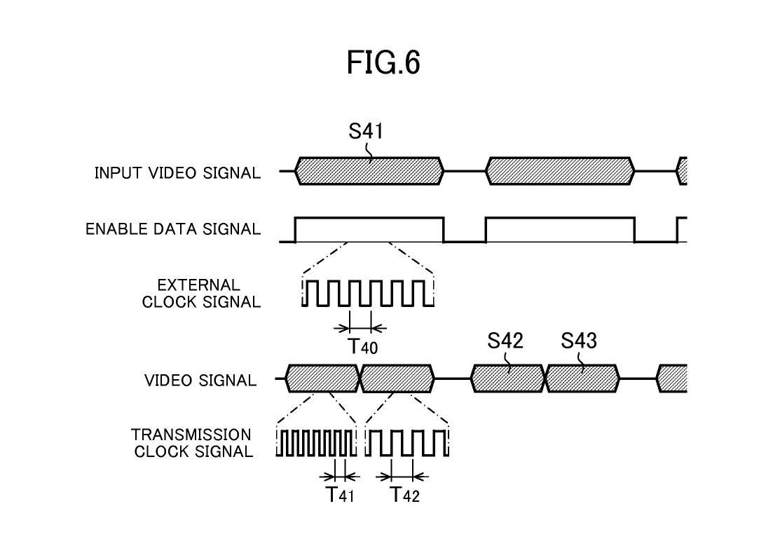

FIG. 6 is a timing chart of a signal related to input/output of the video signal control unit 300 in the system configuration according to this embodiment. As illustrated in FIG. 6, first, an input video signal S41 is stored in the image memory 310 by the aid of the external clock signal similarly to the first embodiment. Then, in a subsequent horizontal synchronizing period in which the input video signal S41 is received, a video signal S42 and a video signal S43 are sequentially transmitted to the source drivers 210. In this example, as a period of the transmission clock signal, periods T₄₁ and T₄₂ of the different transmission clock signals are used for the respective transmissions of the video signals S42 and S43.

In this example, in order to avoid an interference with the wireless communication, a frequency different from an integer multiple or an integral fraction of the wireless frequency used in the wireless communication can be used as the frequency of the transmission clock signal. Also, any one period of the transmission clock, of the periods T₄₁ and T₄₂, is set to an integral multiple of the other period of the transmission clock, to thereby enable noises of the radiated electromagnetic wave to match each other. As a result, the frequency causing the deterioration of the communication sensitivity can be avoided.

In FIG. 6, the video signal S43 uses a period longer than the period of the video signal S42. However, the periods of the video signals S43 and S42 maybe reversed, or transmission clocks of three or more kinds may be used.

Therefore, according to this embodiment, a clock cycle (or frequency) used for transmission of the video signal to be transmitted by the flexible printed circuit 500 can be selected. Therefore, when the clock cycle is set to a cycle in which no wireless communication fails, the wireless communication failure caused by the electromagnetic wave generated from the display device can be reduced without any addition of a specific component.

While there have been described what are at present considered to be certain embodiments of the invention, it will be understood that various modifications may be made thereto, and it is intended that the appended claims coverall such modifications as fall within the true spirit and scope of the invention.

What is claimed is:

1. A display device, comprising:
a driver circuit that is arranged on a display panel, and applies a voltage corresponding to a gradation value to each pixel;
a video signal line for transmitting a video signal to the driver circuit;
a control signal line for transmitting a signal for controlling a timing at which the video signal is transmitted to the driver circuit; and
a video signal control unit that transmits the video signal to the driver circuit through the video signal line and the control signal line,
wherein a transmission clock frequency at which the video signal control unit transmits the video signal to the driver circuit is different from an external clock frequency at which the video signal control unit receives the video signal from an external.

2. The display device according to claim 1,
wherein the video signal is transmitted at the transmission clock frequency higher than the external clock frequency.

3. The display device according to claim 1,
wherein the video signal control unit transmits a plurality of the video signals corresponding to different display positions to functional portions of the driver circuit corresponding to the plurality of video signals at the same time, respectively.

4. The display device according to claim 1,
wherein the video signal control unit transmits the respective video signals by using a plurality of the transmission clock frequencies in a plurality of time zones, and
wherein the plurality of transmission clock frequencies includes a first transmission clock frequency and a second transmission clock frequency which is an integral multiple of the first transmission clock frequency.

5. A video display method, comprising:
inputting and storing a video signal at a timing of an external clock signal;
transmitting the stored video signal to a driver circuit at a timing of a transmission clock signal; and
outputting the transmitted video signal by the driver circuit for display,
wherein the transmission clock frequency is different from the external clock frequency.
